(19) United States
(12) Patent Application Publication
(10) Pub. No.: US 2011/0181080 A1
(43) Pub. Date: Jul. 28, 2011

(54) BABY CAR SEAT SIDE HANDLE ADAPTABLE BAG

(76) Inventor: Sandra C. Frawley, Greenwood Lake, NY (US)

(21) Appl. No.: 13/013,788

(22) Filed: Jan. 25, 2011

Related U.S. Application Data
(60) Provisional application No. 61/336,636, filed on Jan. 25, 2010.

(51) Int. Cl. A47D 15/00; B60N 2/26

(52) U.S. Cl. 297/188.01

(57) ABSTRACT

An accessory storage pouch or bag configured for adaptable attachment to a seating device and which may be in close proximity to a child but which cannot interfere with the child's comfort or safety. The accessory storage pouch comprises: a.) a back panel having a rear surface with a plurality of rearward adjustable attachment fasteners for securely engaging the storage pouch with a seating device in an orientation selected by a user for ease of access to the storage pouch with minimal interference with the seat occupant, the back panel having an area and shape generally defining an overall geometric shape of the storage pouch; b.) a side panel orthogonal to the back panel and bound at a rearward edge to an outer edge of the back panel, thereby and corresponding to a storage volume generally defined together by the area and shape of the back panel and the depth of the side panel attached thereto, the side panel having at least one closure mechanism for permitting access to the interior of the storage pouch; and c.) a front panel generally corresponding in shape and area to the back panel and orthogonal to the side panel, the front panel having an outer edge securely bound to a forward edge of the side panel.

### CROSS-REFERENCE TO RELATED APPLICATION

The present invention relates to and incorporates by reference herein pending U.S. Provisional Patent Application 61/336,636 filed Jan. 25, 2010.

### FIELD OF THE INVENTION

The present invention relates to an adaptable bag that is attachable to a baby car seat side handle. More particularly, the present invention relates to bags that can be removably and adjustably attached to or suspended from infant car seats or carriers.

### BACKGROUND OF THE INVENTION

Busy parents often need to bring their children with them as they go about their daily activities and errands. Fortunately, infant car seats have evolved in such a way that they are easy and comfortable to carry around. Without disturbing the infant, the infant carrier can be clipped safely into a car seat, stroller frame or shopping cart, or moved from place to place. Parents carrying their infants in these carriers often also have to carry a variety of other bags containing diapers, bottles, toys, wallets, keys, personal items, and other items related to the errand or activity being accomplished. It can be difficult to keep track of all the bags or items and things can easily be lost or left behind.

It is desirable to consolidate some of these items and bags in such a way that will alleviate some of the parent's burden and simplify their tasks, while keeping the items accessible. Having an efficient and adaptable storage system that attaches right to the infant carrier will keep necessary items accessible while minimizing the chances of misplacement.

### SUMMARY OF THE INVENTION

The subject infant travel seating system has an accessory storage pouch or bag configured for adaptable attachment to a seating device and which may be in close proximity to a child but which cannot interfere with the child's comfort or safety. The accessory storage pouch comprises: a.) a back panel having a rear surface with a plurality of rearward adjustable attachment fasteners for securely engaging the storage pouch with a seating device in an orientation selected by a user for ease of access to the storage pouch with minimal interference with the seat occupant, the back panel having an area and shape generally defining an overall geometric shape of the storage pouch; b.) a side panel orthogonal to the back panel and bound at a rearward edge to an outer edge of the back panel, thereby and corresponding to a storage volume generally defined together by the area and shape of the back panel and the depth of the side panel attached thereto, the side panel having at least one closure mechanism for permitting access to the interior of the storage pouch; and c.) a front panel generally corresponding in shape and area to the back panel and orthogonal to the side panel, the front panel having an outer edge securely bound to a forward edge of the side panel.

As used herein, the expression “bound” refers to a secure physical or mechanical attachment between the panels and may be accomplished by several means including without limitation binding with stitches, piping, tack welding, curable adhesives or hot glue.

The adjustable attachment fasteners may be selected from belts, loops, hook and loop fasteners, buckles, ties, snaps and similar mechanical fasteners.

In some embodiments, the interior surface of the back panel may have one or more functional storage compartments. The pouch has an upper side panel opening and complementary closing mechanism for top access to interior accessory storage. Typically these will be selected from zipper, flap, hook and loop, snap button and clasp fasteners. The side panel may be comprised of a plurality of bound panels, at least one of which may be a bottom panel configured for setting the pouch on a surface.

The pouch will typically have a front panel opening and complementary closing mechanism for forward access to interior accessory storage, fasteners for which may be selected from zipper, flap, hook and loop, snap button and clasp fasteners. In some embodiments the pouch or bag may have handle or shoulder strap attachment loops or clasps. An infant travel seating system as in claim 1 wherein the front panel further comprises a pocket, sleeve, flap, purse, lid or shelf.

The pouch interior may have panels adaptable for organization of storage compartments. The interior of the front panel also may further comprise one or more separate storage compartments.

Other objects, features and advantages of the present invention will be apparent when the detailed descriptions of the preferred embodiments of the invention are considered with reference to the accompanying drawings, which should be construed in an illustrative and not limiting sense as follows:

### BRIEF DESCRIPTION OF THE DRAWINGS

FIG. 1 is a perspective view of a preferred embodiment of the subject adaptable bag.

FIG. 2 is a rear elevational view of the embodiment shown in FIG. 1.

FIG. 3 is a perspective view of the embodiment of FIG. 1 shown in combination with an infant car seat.

FIG. 4 is a rear elevation view of an alternative embodiment of the subject adaptable bag.

FIG. 5 is a perspective view of an alternative embodiment of the subject adaptable bag.

FIG. 6 is a perspective view of the embodiment of FIG. 5, having an alternate configuration.

### DETAILED DESCRIPTION OF THE PREFERRED EMBODIMENTS

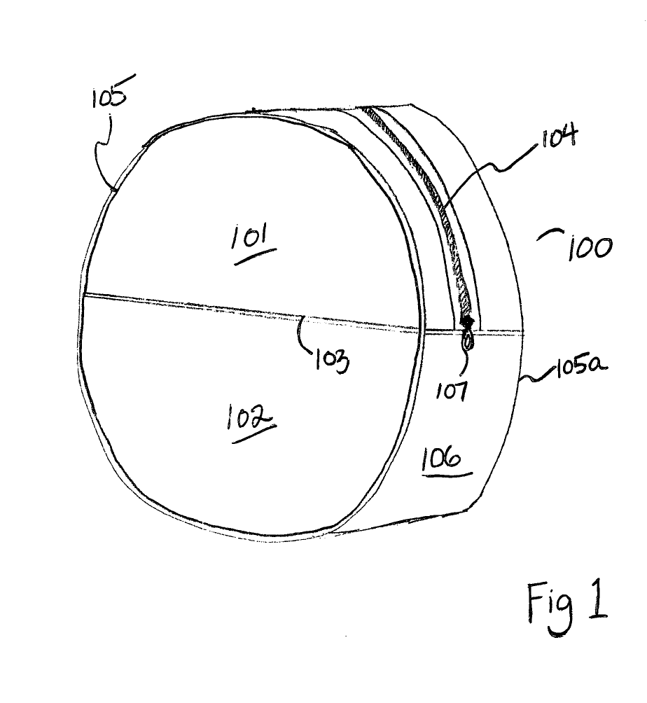

The adaptable bag as shown in FIGS. 1-6 is a bag made of flexible materials which may include a variety of materials such as fabrics, canvas, leather, thermoplastic sheet or microfiber fabric. Nylon and polyester fabrics may also be used. A preferred adaptable bag is zippered on the top, has one or two front pockets with a flap or lid covering the pockets which may be closed with either buttons, hook and loop closures, snaps, buckles or zippered. There are two nylon straps that are sewn onto the back of the bag which will then have parachute buckles for the strap to wrap around the baby car seat handle on the side and clicked together to be secured into place.

A further preferred embodiment 100 is depicted in FIG. 1, showing the front panel 101 of the bag having a generally circular shape, although it will be recognized that other shapes are possible. There is a front exterior pocket 102 on the front panel 101, having an exterior pocket opening 103 at the top of the exterior pocket 102. The exterior pocket may optionally have a variety of closure mechanisms, including but not limited to buttons, zippers, hook and loop tape, snaps or any other suitable closure mechanism, none of which are depicted here. Front edge 105 is between front panel 101 and side panel 106. Rear edge 105a is between side panel 106 and rear panel 108 (not shown). The edges will typically, for strength and durability, be trimmed with piping of suitable fabric or finishing material. Also seen in this figure is the zipper 104 which is sewn into the top of the side panel 106 of bag 100, providing a secure closure for the opening of the bag. A zipper slider and pull tab mechanism 107 for operating the zipper is also provided. It will be recognized that while a zipper is a preferred method for securely closing the bag, other closure mechanisms or methods may be used, including buttons, hook and loop tape, snaps or the like.

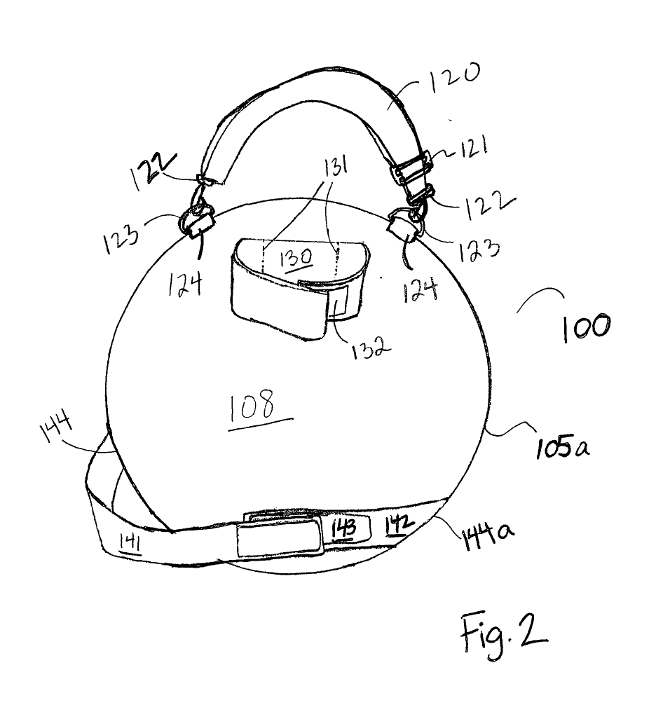

FIG. 2 is a rear elevational view of the embodiment shown in FIG. 1. In this view, the upper adjustable carrier attachment strap 130 is visible. The upper adjustable carrier attachment strap 130 is secured to the rear panel 108 of the bag 100 with stitching seams 131. It will be recognized that other methods of attachment may be used to attach the adjustable carrier attachment strap 130 to the rear panel 108, including stitching, hot glue or other adhesive. In this embodiment, adjustable carrier attachment strap 130 utilizes a patch of hook and loop closure mechanism 132 to securely clasp the opposite ends of the strap 130 together, typically around the side of a baby carrier seat handle. In this embodiment, the lower adjustable carrier attachment straps 141 and 142 are attached to the bag 100 by being sewn into the rear edge 105a at seams 144 and 144a, respectively. In other embodiments, the straps 141 and 142 may be securely attached to the side panel 106 of the bag 100, by means of sewing, glue, adhesive, or other secure attachment. In this embodiment, the lower adjustable carrier attachment straps 141 and 142 may be adjustably clasped together using a patch of hook and loop closure mechanism 143, typically around the side of a baby carrier seat handle. It will be recognized that in lieu of hook and loop closure mechanisms 132 and 143, other means of secure yet temporary closure may be used, such as snaps, buckles or buttons, or other suitable methods. In some embodiments, parachute style snap buckles have been found to be useful.

Also shown in FIG. 2 is a detachable carrying strap 120 having clasping means 122 at each opposite end for engaging with hardware 123 being secured to the bag 100 by fabric tubes 124. It will be recognized that the optional detachable carrying strap may be fabricated of a variety of materials, including fabric, rope, canvas, nylon or any other suitable material. In this embodiment, the strap 120 is adjustable via a slidable clip 121 which allows the strap to be made longer or shorter. Additionally, in this embodiment the clasping means 122 shown is an openable clip that may be fabricated of plastic or metal, that when opened, may be removed from the bag 100. Toggle clasps and other stylish clips may also be used. In this embodiment, the hardware 123 to which the clasping means 122 attaches are D-rings, which may be made of metal, plastic or reinforced fabric, or any other suitable material and may be used in any suitable or stylish shape, including O-rings or others.

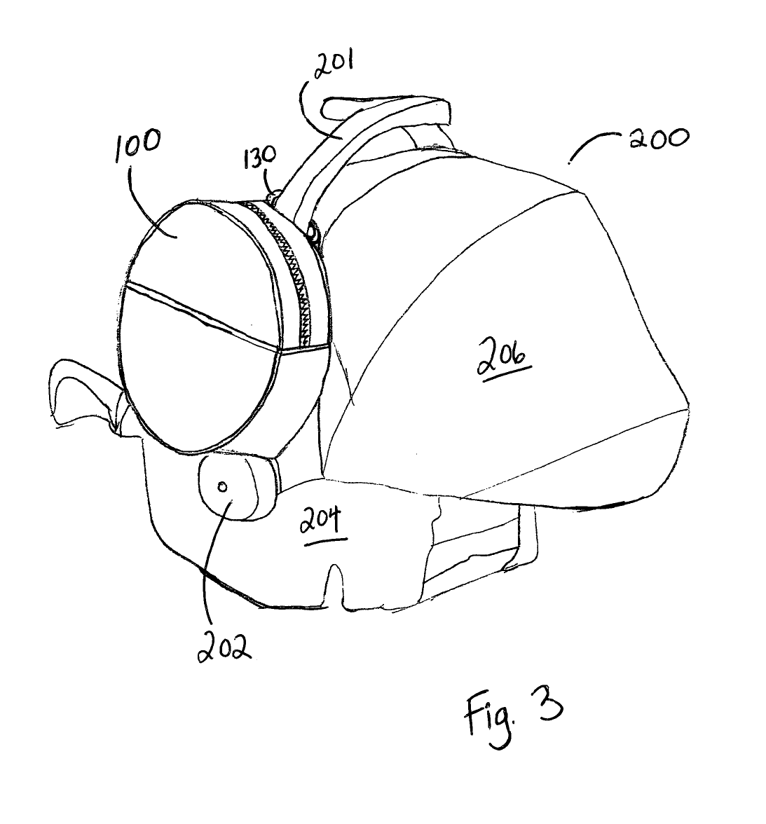

FIG. 3 is a perspective view of the embodiment of FIG. 1 with a top closure shown in use in a combined infant seat system 200. The baby carrier seat has handle 201 which is typically rotationally adjustable, and here is shown in the upright position. In this figure, it is seen how the bag 100 will attach on the side of the baby carrier seat handle 201 on the side, just above the seat handle rotational pivot 202. The upper adjustable carrier attachment strap 130 can also be seen in this figure as wrapped and secured around the baby carrier seat handle 201. As the handle position varies, the bag will move with the handle and is efficacious regardless of the orientation of the handle 201. Also seen in FIG. 3 is car seat base 204 and seat hood 206.

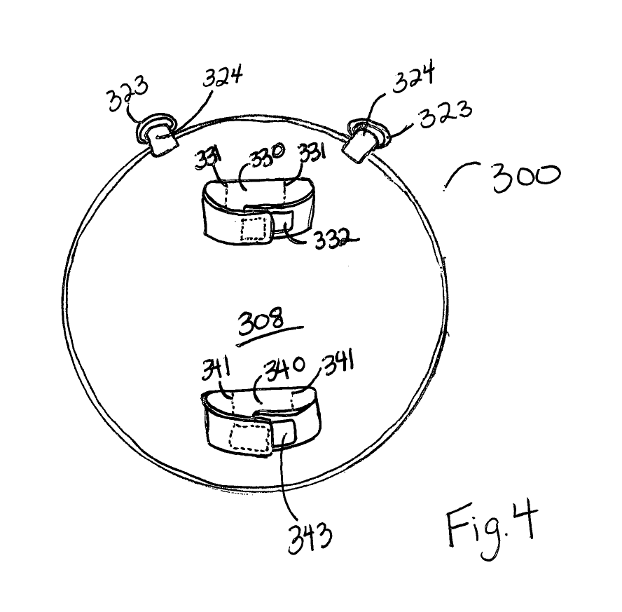

FIG. 4 is a rear elevation view of an alternative embodiment 300 of the subject bag. In this embodiment, the upper and lower adjustable carrier attachment straps 330 and 340 respectively, are substantially the same size as each other. Similarly to the embodiment shown in FIG. 2, the upper and lower adjustable carrier attachment straps 330 and 340 respectively, may be secured to the rear panel 308 by stitching seams 331 and 341 respectively, or any other suitable means for attaching the straps to the panel, such as glue, adhesive, sewing, or other attachment means. Also similarly to the adjustable carrier attachment straps in FIG. 2, the straps 330 and 340 in this embodiment may utilize hook and loop patches 332 and 343 respectively to close upon themselves for securing around the baby carrier seat handle. It will be recognized that in lieu of hook and loop closure mechanisms 332 and 343, other means of secure yet temporary closure may be used, such as snaps, buckles or buttons, or other suitable methods. Also visible in this figure are the optional means for attaching a removable hand or shoulder strap (not shown), i.e. fabric tubes 324 and D-rings 323 which are similar to those discussed above in FIG. 2. The adaptable bag embodiment 300 as seen in FIG. 4 will have utility in car seat systems having handle configurations suitable for engaging straps 330 and 340 in an above-below arrangement.

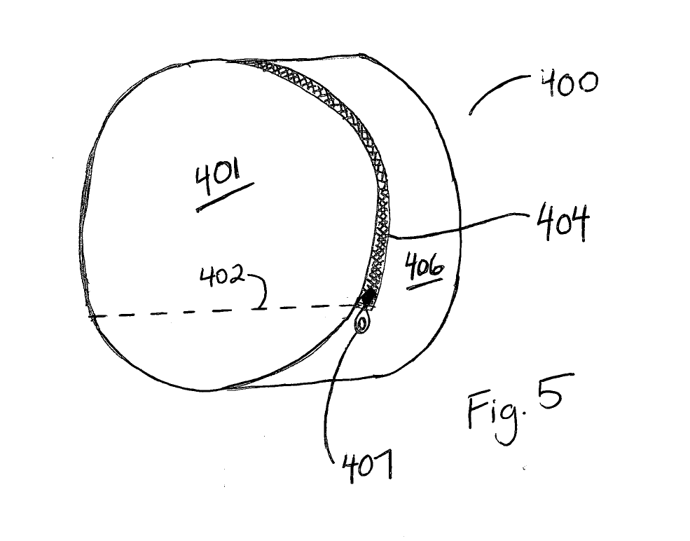

FIG. 5 is a front perspective view of an alternative embodiment 400 of the subject bag having the placement of the zipper 404 and slider and pull tab 407, along the forward edge between the front panel 401 and side panel 406. In addition to a change in placement of the zipper in this embodiment, also shown in this figure is a generally longer zipper closure which permits a larger opening into the bag when opened. In this figure, the dotted line 402 shows where the front panel 401 may fold forward when the zipper 404 is open. Front panel 401 may be adapted or configured to open partially or completely. A partial opening panel may be used as a small shelf.

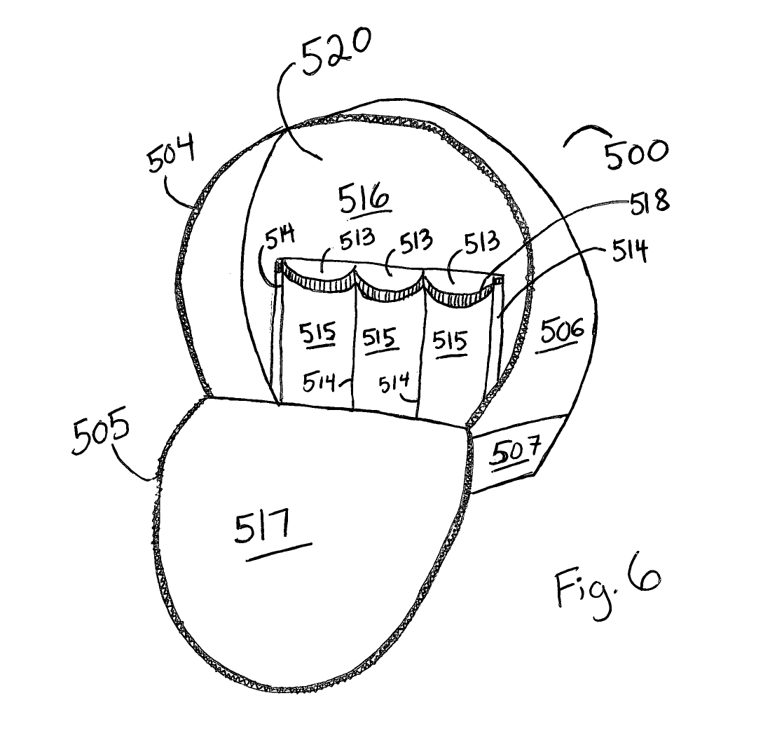

FIG. 6 is a perspective view of a further embodiment 500 of the subject bag. This embodiment is similar to the embodiment shown in FIG. 5, having a longer zipper that allows for a larger opening into the interior compartment 520 of the bag 500. In this view of the interior, one of many possible configurations of interior pockets is disclosed. Here, a piece of material 515 that may be fabricated of fabric, plastic, nylon, or any other suitable material, forms a trio of pockets 513 by being sewn or glued onto the interior side of rear panel 516, and secured to the panel 516 at seams 514. This embodiment includes optional elastic trim 518 along the upper edge of the pockets to help the pockets maintain their shape and stability whether or not they are in use. The interior of front panel 517 is seen folded down along fold line 502 as the bag 500 is in the open position and the open zipper is in two parts 504 and 505. Further seen in this embodiment is the possibility of having multiple panels comprising the sides of the bag. Here upper side panel 506 adjoins the zipper 504, while lower side panel 507 forms the bottom portion of the bag 500. The lower side panel may be fabricated of a tougher material for added durability and stability when removed from the baby carrier seat and set down on the ground or other surfaces.

The invention now being fully described, it will be apparent to one of ordinary skill in the art that many changes and modifications can be made thereto without departing from the spirit or scope of the invention set forth herein.

1. An infant travel seating system having an accessory storage pouch configured for adaptable attachment to a seating device, the accessory storage pouch comprising:
a. a back panel having a rear surface with a plurality of rearward adjustable attachment fasteners for securely engaging the storage pouch with a seating device in an orientation selected by a user for ease of access to the storage pouch with minimal interference with an infant, the back panel having an area and shape generally defining an overall geometric shape of the storage pouch;
b. a side panel orthogonal to the back panel and bound at a rearward edge to an outer edge of the back panel, thereby and corresponding to a storage volume generally defined together by the area and shape of the back panel and the depth of the side panel attached thereto, the side panel having at least one closure mechanism for permitting access to the interior of the storage pouch;
c. a front panel generally corresponding in shape and area to the back panel and orthogonal to the side panel, the front panel having an outer edge securely bound to a forward edge of the side panel.

2. An infant travel seating system as in claim 1 wherein the interior surface of the back panel has one or more functional storage compartments.

3. An infant travel seating system as in claim 1 wherein the pouch has an upper side panel opening and complementary closing mechanism for top access to interior accessory storage which is selected from zipper, flap, hook and loop, snap, button and clasp fasteners.

4. An infant travel seating system as in claim 1 wherein the pouch has a front panel opening and complementary closing mechanism for forward access to interior accessory storage which is selected from zipper, flap, hook and loop, snap, button and clasp fasteners.

5. An infant travel seating system as in claim 1 wherein the pouch has handle or shoulder strap attachment loops or clasps.

6. An infant travel seating system as in claim 1 wherein the side panel is comprised of a plurality of bound panels, at least one of which is a bottom panel configured for setting the pouch on a surface.

7. An infant travel seating system as in claim 1 wherein the front panel further comprises a pocket, sleeve, flap, lid, shelf or purse.

8. An infant travel seating system as in claim 1 wherein the pouch interior comprises panels adaptable for configuring of interior storage compartments.

9. An infant travel seating system as in claim 1 wherein the panels are bound with stitches, piping, tack welding, curable adhesives or hot glue.

10. An infant travel seating system as in claim 1 wherein the interior of the front panel further comprises one or more separate storage compartments.

11. An infant travel seating system as in claim 1 wherein the adjustable attachment fasteners are selected from belts, loops, hook and loop fasteners, buckles, ties or snaps.

12. An infant travel seating system as in claim 1 further comprising a travel seat physically engaged with the storage pouch.

13. An infant travel seat accessory storage pouch configured for adaptable attachment to a seating device, the accessory storage pouch comprising:
a. a back panel having a rear surface with a plurality of rearward adjustable attachment fasteners for securely engaging the storage pouch with a seating device in an orientation selected by a user for ease of access to the storage pouch with minimal interference with an infant, the back panel having an area and shape generally defining an overall geometric shape of the storage pouch;
b. a side panel orthogonal to the back panel and bound at a rearward edge to an outer edge of the back panel, thereby and corresponding to a storage volume generally defined together by the area and shape of the back panel and the depth of the side panel attached thereto, the side panel having at least one closure mechanism for permitting access to the interior of the storage pouch;
c. a front panel generally corresponding in shape and area to the back panel and orthogonal to the side panel, the front panel having an outer edge securely bound to a forward edge of the side panel.
